(19) United States
(12) Patent Application Publication
(10) Pub. No.: US 2007/0093299 A1
(43) Pub. Date: Apr. 26, 2007

(54) Wagering game with virtual reward

(76) Inventors: Daniel Bergeron, North Attleboro, MA (US); Thomas Napolitano, East Greenwich, RI (US)

Correspondence Address: KENYON & KENYON LLP, ONE BROADWAY, NEW YORK, NY, 10004, US

(21) Appl. No.: 11/521,794

(22) Filed: Sep. 15, 2006

Related U.S. Application Data
(60) Provisional application No. 60/717,918, filed on Sep. 15, 2005.

(51) Int. Cl. A63F 13/00

(52) U.S. Cl. 463/43; 463/47

(57) ABSTRACT

A system and method for conducting a wagering game in accordance to a set of pre-determined game rules is disclosed. The system may include a host and a gaming terminal in communication with the host. The system may also include a game piece provided to a player, the game piece including game play data. A virtual reward redemption code may be included on the game piece. A virtual reward may be awarded to a player after submission of the virtual reward redemption code if game play data indicates the game piece is a winner in accordance to the set of pre-determined game rules.

### BACKGROUND

Lottery games involve purchasing a chance or wager, usually in the form of a ticket. Whether the chance is a winner is randomly determined. A winning chance may be redeemed for prizes such as cash or merchandise or other prizes of value. The value of prizes may also depend on a random element, for example, the outcome of a sporting event. Lottery games include both future-draw lottery games and instant-win lottery games. Lotto and keno are two examples of future-draw lottery games, where the winning status of a ticket is determined at some point after the purchase of the ticket. In an instant-win or instant lottery game, whether a ticket or chance is a winner is determined before or at the time of purchase. Thus, a winning instant lottery ticket may typically be redeemed for a prize immediately. Common types of instant win lottery games include pre-printed tickets such as pull-tab tickets, peel-off tickets, or scratch-off tickets.

A Massively Multiplayer Online Game (MMOG) is an online game with a large number of human players. Popular MMOGs include World of Warcraft from Blizzard Entertainment Inc., Everquest from Sony Corporation, and Ultima Online from Electronic Arts Inc. A MMOG provides a virtual world and a number of avatars. Each player may control one or more avatars. An avatar is a graphical representation of a character in the MMOG. Each avatar has a variety of attributes and characteristics. Each avatar may also have a variety of virtual objects to be used in the MMOG. For example, objects may include weapons, armor, or other objects that improve or benefit the avatar.

Typically, virtual objects are gained through an avatar's adventures throughout the MMOG virtual world. Similarly, an avatar's characteristics and attributes may be improved through its adventures. The virtual world may be pre-seeded with adventures or quests to complete, enemies to be defeated, objects to find and other opportunities for advancement.

A MMOG typically employs real-world administrator programmers to oversee the virtual world, enforce game rules and to update and enhance the virtual world. Each player has an account on a MMOG server which he may log into when he wishes to play in the game. The account is typically paid for on a monthly subscription-basis, although metered access or other alternative payment schemes are also used. A player may also pre-pay his subscription in advance for a longer period of time. Some games are provided free as “shareware” or on a promotional basis.

The demographics of MMOG players typically differ from traditional lottery games. MMOG players are typically younger than traditional lottery game players, and are much heavier users of the Internet. As such, they may not be much exposed to traditional channels of advertisements for lottery games. Likewise, lottery game players are not much exposed to traditional channels of advertisements for MMOGs.

### BRIEF DESCRIPTION OF THE DRAWINGS

FIG. 1 illustrates an example game piece, according to an example embodiment of the present invention.

FIG. 2 illustrates an example wagering game system, according to an example embodiment of the present invention.

FIG. 2a illustrates an example lottery host system, according to an example embodiment of the present invention.

FIG. 2b illustrates an example MMOG host system, according to an example embodiment of the present invention.

FIG. 3 illustrates an example procedure for conducting a wagering game, according to an example embodiment of the present invention.

FIG. 3a illustrates a second example procedure for conducting a wagering game, according to an example embodiment of the present invention.

FIG. 4 illustrates a third example procedure for conducting a wagering game, according to an example embodiment of the present invention.

FIG. 4a illustrates a fourth example procedure for conducting a wagering game, according to an example embodiment of the present invention.

FIG. 5a illustrates an example embodiment of a game ticket information table, according to another example embodiment of the present invention.

FIG. 5b illustrates an example embodiment of a game ticket information table entry, according to an example embodiment of the present invention.

FIG. 6 illustrates an example procedure for communication between a lottery host and a MMOG host, according to another example embodiment of the present invention.

FIG. 7 illustrates an example embodiment the present invention.

FIG. 8a illustrates an example embodiment of a play log table, according to an example embodiment of the present invention.

FIG. 8b illustrates an example embodiment of a play log table entry, according to an example embodiment of the present invention.

FIG. 9a illustrates an example embodiment of a transaction log table, according to an example embodiment of the present invention.

FIG. 9b illustrates an example embodiment of a transaction log table entry, according to an example embodiment of the present invention.

### DETAILED DESCRIPTION OF EXAMPLE EMBODIMENTS

An example embodiment of the present invention may include a conventional wagering game, such as an instant win lottery game or a future draw lottery game which is tied to an MMOG. An additional virtual reward redemption code may be provided on each game piece in the conventional wager game. In addition to playing the wagering game with the game piece, a player may redeem the virtual reward redemption code for a virtual prize in the MMOG, for example by submitting the virtual reward redemption code at a video game terminal or personal computer to an MMOG host. The virtual prize may be a virtual object or other benefit for the player's avatar in the MMOG provided by the MMOG host. A virtual prize may also be a chance to win an award. Each game piece may also provide an opportunity to win a second prize, for example, a monetary prize. Providing this tie between the MMOG and conventional wager game may allow cooperative marketing between the conventional wager game provider and the MMOG provider, e.g., by inducing MMOG players to try conventional wager games or vice versa.

A second example embodiment of the present invention may include a conventional wagering game, such as an instant win lottery game or a future draw lottery game, with a variety of awards available. Example awards include cash, merchandise, points, or other benefits for the player. One of the awards available in the conventional wagering game, in addition to conventional awards, may be a virtual prize for use in an MMOG. If the player wins a virtual prize, he may receive his prize by submitting a game piece identifier to the MMOG host. The virtual prize may then be provided to the player's avatar in the MMOG.

Another example embodiment of the present invention may include a host. The virtual reward redemption code may be submitted to the host for processing. In another example embodiment of the present invention, a terminal may receive the virtual reward redemption code from the player. The terminal may be in communication with the host.

Another example embodiment of the present invention may conduct a wagering game on a gaming device. A player may be provided with a chance in the wagering game. The chance is determined to be a winning chance or not. If the chance is a winning chance, the player is provided with a prize. The player may also be provided with a virtual reward. The player may also receive a receipt, the receipt including a win information. The gaming device may be a video lottery terminal or a video slot machine. The virtual reward may be a virtual object used in a video game. The prize may be provided after the player enters the win information into a terminal.

Another example embodiment of the present invention may include a system for conducting a wagering game, including: a host, a gaming terminal in communication with the host, a game piece provided to a player, a game play data included on the game piece, a virtual reward redemption code included on the game piece, and a virtual reward. The virtual reward may be awarded to a player if the virtual reward redemption code is a winner in accordance to a set of pre-determined game rules.

Another example embodiment of the present invention may include a system for conducting a wagering game, including: a host, a gaming terminal in communication with the host, a game piece provided to a player, a game piece identifier included on the game piece, and a virtual reward awarded to a player if the game piece identifier is associated with a winning game piece.

Another example embodiment of the present invention may include a lottery ticket, including: a game data for a lottery game, a ticket identifier, and a virtual reward redemption code configured to identify the lottery ticket as a winning ticket and notify a host to provide a virtual reward in an MMOG. The virtual reward redemption code may be included in the ticket identifier.

Another example embodiment of the present invention may include a computer-readable medium storing instructions adapted to be executed by a processor, the instructions, when executed, conducts a wagering game by: providing a game piece to a player, the game piece including game play data and a virtual reward redemption code, redeeming the game piece for a monetary prize, submitting the virtual reward redemption code to a host, using the virtual reward redemption code to determine if the player is a winner of a virtual reward, and if the player is a winner of the virtual reward, providing the virtual reward as a prize to the player. The value of the monetary prize may depend on the game play data

Another example embodiment of the present invention may include a computer-readable medium storing instructions adapted to be executed by a processor, the instructions, when executed, conducts a wagering game by: providing a game piece to a player, the game piece including a game piece identifier and game play data for the wagering game, redeeming the game piece for a monetary prize in the wagering game, the prize depending on the game play data, receiving a request to redeem the game piece for a virtual prize, the request including the game piece identifier, determining if the game piece identifier is associated with a virtual reward winning game piece, and if the game piece is a virtual reward winning game piece, providing the virtual reward as a prize to the player.

Another example embodiment of the present invention may be a MMOG environment providing a virtual casino to users. The MMOG may include a number of avatars, each avatar controlled by a player. A player may interact with other players and with the virtual casino through their avatars. The virtual casino would provide a variety of games of chance, including conventional games such as poker, blackjack, keno, sports betting and craps. Users would be able to deposit currency into their account and wager in the virtual casino with currency-equivalents. Such currency-equivalents may be virtual casino chips. Such virtual casino chips may be a virtual reward in a wagering game.

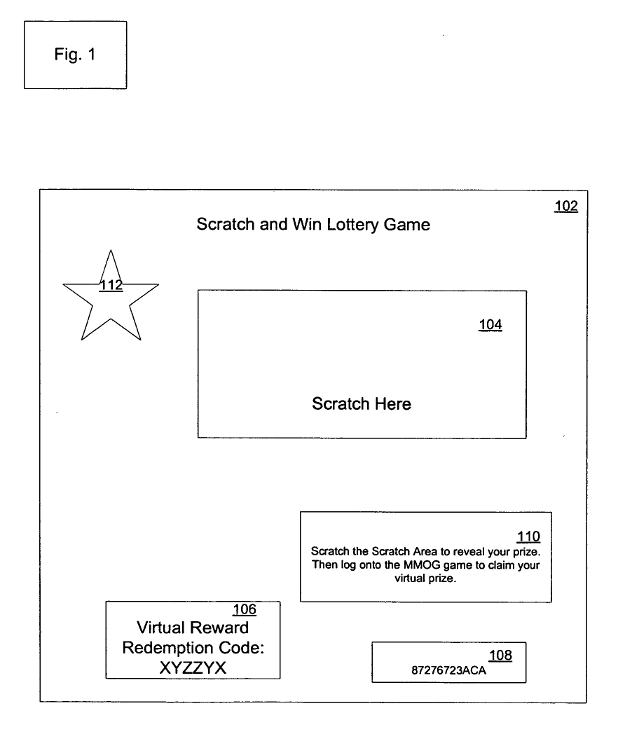

FIG. 1 illustrates an example game piece, according to an example embodiment of the present invention. A conventional scratch and win lottery ticket may be modified to create an example game piece 102. Other types of game pieces may also be modified, such as a future draw lottery ticket. The scratch and win lottery game ticket 102 may include a scratch area 104. The scratch area 104 may include a lottery game data used by a player to determine if the game ticket 102 is a winning ticket or not in accordance to a set of pre-determined game rules. The pre-determined game rules may be provided to the player via a communication channel. For example, the rules may be provided through a website maintained by the lottery provider. Alternatively, the rules may be provided through a brochure available where lottery game tickets are sold, or be printed on individual lottery game tickets.

The lottery game data may be graphics or representations of alpha-numeric characters. The lottery game data may provide the player with a first chance to win, the first chance generally being for a conventional prize. For example, the conventional prize may be cash or merchandise. The lottery game data may be evaluated for the presence of a particular pattern in accordance with the pre-determined game rules, e.g., matching numbers, or compared to an externally provided set of winning game data. The scratch area 104 may be covered by a layer of opaque scratch-off material which renders the lottery game data invisible to the ticket purchaser prior to removing the scratch-off material. For example, the scratch-off material may be rubber, plastic, latex or silicon. The layer of scratch-off material may include instructions visible to a player. For example, the instructions may read “Scratch Here.”

The game ticket 102 may also include a virtual reward redemption code 106. The code 106 may provide the player with a chance to win a virtual reward. For example, the code 106 may be an alpha-numeric code to be inputted into a video game. The code 106 may be redeemed in the video game for a virtual prize. The code 106 may be redeemed in a MMOG. Although virtual reward redemption code 106 is shown separately from the game play data and scratch off area, it will be appreciated that it could also be placed under the game play data scratch off area next to the game play data, or, alternatively, under a separate removable layer.

The game ticket 102 may also include a game ticket identifier 108. The ticket identifier 108 may be a unique alpha-numeric code to identify the game ticket 102 within a lottery game. The ticket identifier 108 may or may not be unique within the lottery game.

The game ticket 102 may also include game play instructions 110. For example, play instructions 110 may include instructions on how to play the lottery game, rules of the lottery game, advertising material or other information.

The game ticket 102 may also include graphics 112. For example, graphics 112 may include a logo, images of possible prizes in the lottery game, game graphics or visually attractive images. The graphics 112 may stimulate customer interest and encourage purchases.

Although the example game piece has been described with reference to a conventional scratch-off lottery ticket, it will be appreciated that similar modifications could be made to other wagering games, e.g., a future draw lottery ticket, a keno type ticket, etc.

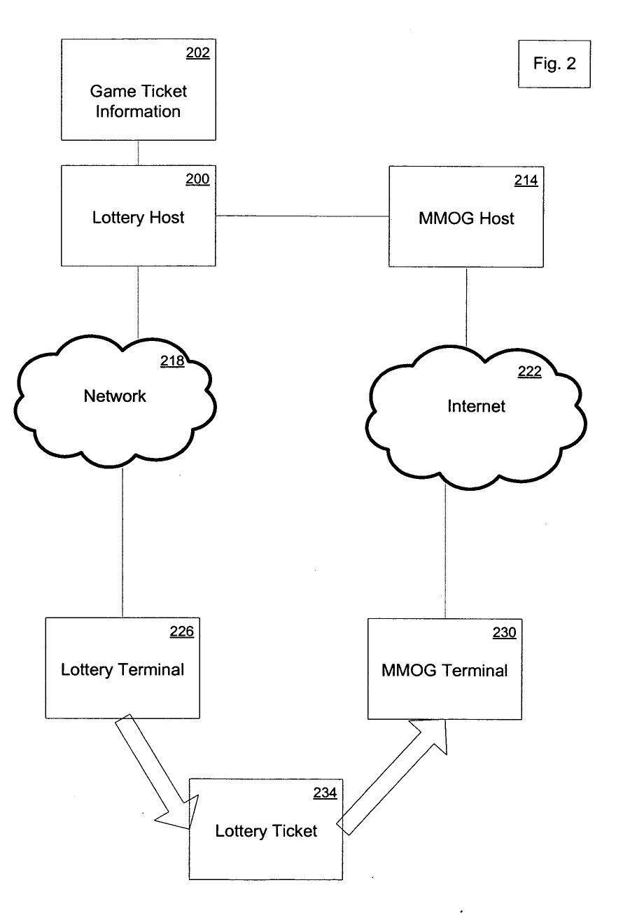

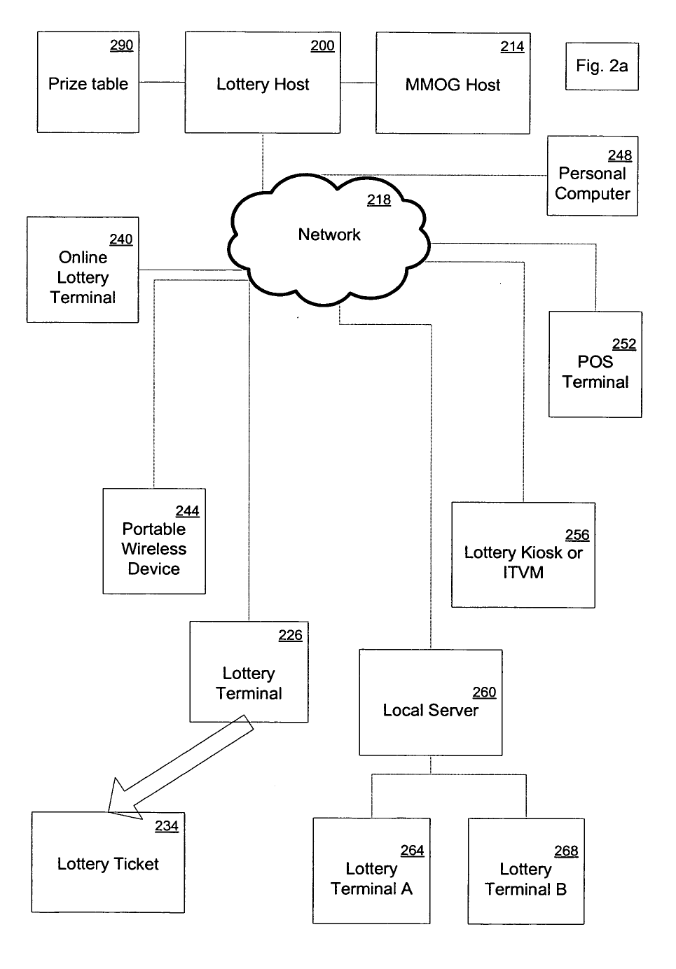

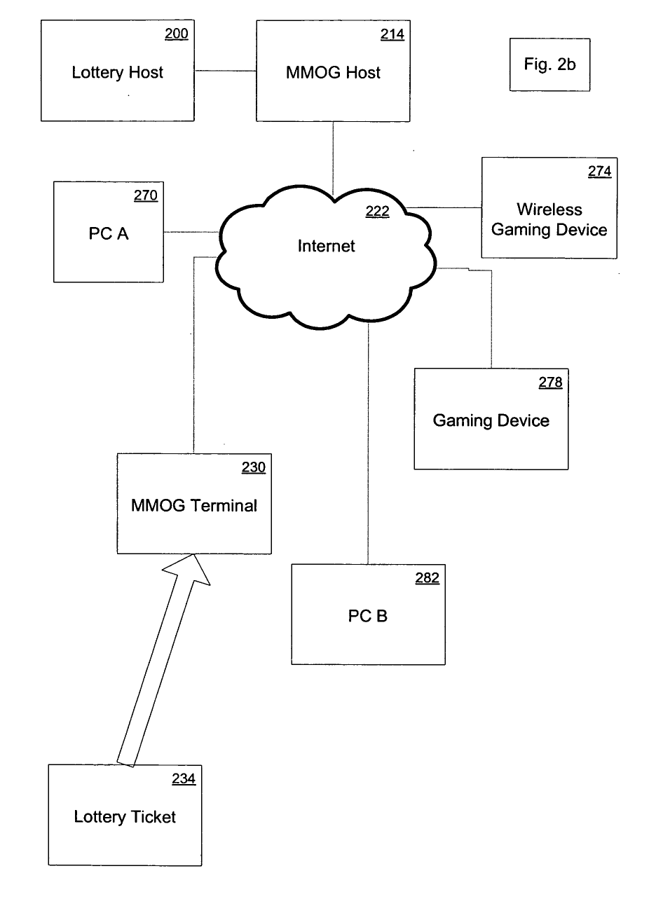

FIG. 2 illustrates an example wagering game system, according to an example embodiment of the present invention. A lottery host 200 may be in communication with a MMOG host 214. The lottery host 200 may be configured to run a lottery game. The lottery host 200 may communicate with lottery terminal 226 through a network 218. For example, the network 218 may be the Internet, a private network or an existing network adapted for communications. The communications over the network 218 may be secured by encryption or other methods.

The lottery host 200 may access game ticket information 202. Game ticket information 202 may be stored on a hard drive or other media. Game ticket information 202 may be stored in a flat file, a relational database, or by some other method. Game ticket information 202 may be encrypted or otherwise secured.

The lottery terminal 226 may dispense a lottery ticket 234 to a player. The lottery ticket 234 may include a game piece identifier or a virtual reward redemption code. The lottery terminal 226 may be a stand-alone kiosk configured to dispense tickets to players. The lottery terminal 226 may be a terminal placed at a check-out counter in a convenience store, to be operated by a clerk. The lottery terminal 226 may be a terminal used by an authorized agent of a lottery game to dispense tickets sold to players. The lottery terminal 226 may be an automated, self-service lottery terminal.

The system may include a MMOG host 214. The MMOG host 214 may be configured to host an MMOG game and communicate with a MMOG terminal 230 over the Internet 222. A player may log into a MMOG game from a MMOG terminal 230 and submit a virtual reward redemption code or a game piece identifier to the MMOG terminal 230. For example, the MMOG terminal 230 may be a personal computer (PC) loaded with a MMOG client software. The MMOG terminal 230 may transmit the information to the MMOG host 214 through the Internet 222. The transmission may be secured, for example, by encryption. The MMOG host 214 may verify the validity of the information and award the player a virtual reward.

FIG. 2a illustrates an example lottery host system, according to an example embodiment of the present invention. The lottery host 200 may be in communication with a MMOG host 214, as previously described. The lottery host 200 may communicate with a variety of lottery terminals. For example, terminals may include an online lottery terminal 240, a portable wireless device 244, a lottery kiosk or ITVM 256, a personal computer 248, a point of sales (POS) terminal 252. There may also be a local server 260 connected to lottery terminal A 264 and lottery terminal B 268.

The communications between the lottery host 200 and the various lottery terminals may be encrypted or otherwise secured.

For example, lottery terminal 226 may dispense a lottery ticket 234. The lottery ticket may include a virtual reward redemption code or a game piece identifier.

FIG. 2b illustrates an example MMOG host system, according to an example embodiment of the present invention. The MMOG host 214 may be in communication with a lottery host 200. The MMOG host may communicate with MMOG terminals through the Internet 222. For example, a MMOG terminal may be a personal computer A 270, a personal computer B 282, a gaming device 278 or a wireless gaming device 274. Communications conducted over the Internet 222 may be encrypted or otherwise secured.

A MMOG terminal 230 may receive a virtual reward redemption code or a game piece identifier from a player. The virtual reward redemption code or game piece identifier may be included on a lottery ticket 234.

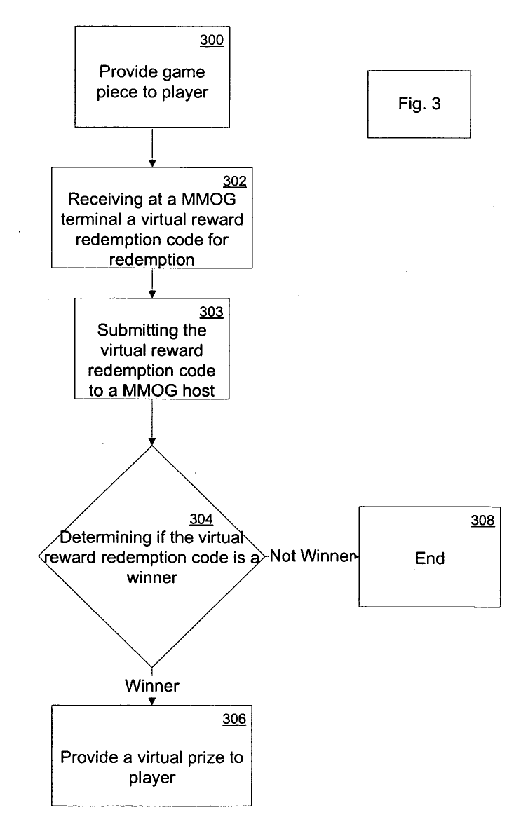

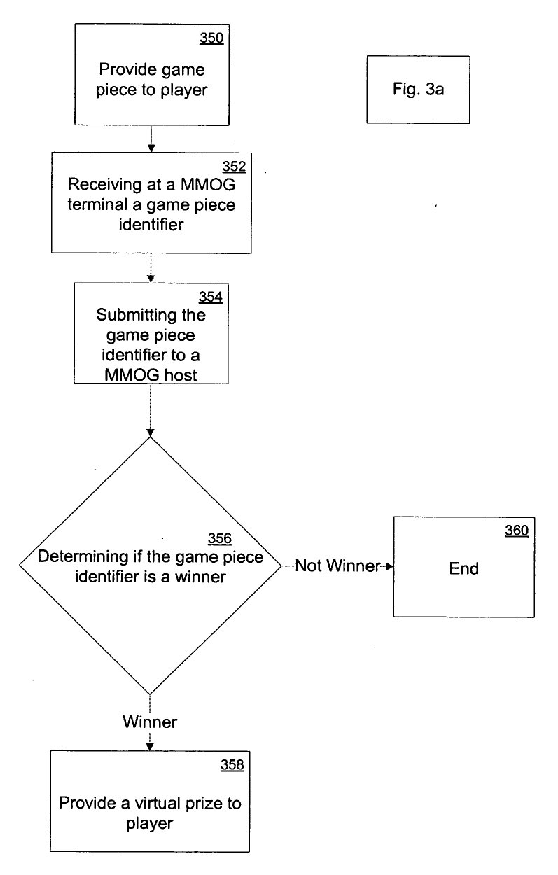

FIG. 3 illustrates an example procedure for conducting a game of chance, according to an example embodiment of the present invention. In 300, a game piece may be provided to a player. The player may purchase the game piece at a convenience store, a lottery ticket kiosk, or other location where lottery tickets are available. For example, a player may purchase a game piece with cash, credit card, points, or other consideration. Alternatively, a player may receive the game piece for free.

The game piece may include a lottery game. For example, the lottery game may be a scratch and win game, a future draw game, or an online lottery game. The game piece may include a game piece data and a virtual reward redemption code

In 302, the player may submit the virtual reward redemption code for redemption to a MMOG terminal. The virtual reward redemption code may be an alpha-numeric sequence or another code a player may submit to a MMOG terminal and transferred over a network.

In 303, the MMOG terminal may submit the virtual reward redemption code to a MMOG host. The MMOG terminal may be a personal computer, a gaming console, a mobile phone, a wireless personal digital assistant (PDA), a video lottery terminal, a slot machine, a video slot machine or any other terminal configured to communicate with a host.

In 304, the MMOG host may determine if the virtual reward redemption code is a winner. The host may include a table of winning virtual reward redemption code. In this example, the host will look up the virtual reward redemption code in the table to determine if the virtual reward redemption code is a winner. Alternatively, the host may randomly select the winning status of a virtual reward redemption code as it receives the virtual reward redemption code. The host may first verify the authenticity of the virtual reward redemption code. For example, the virtual reward redemption code may be encoded with a checksum value or other security measure. Alternatively, the MMOG host may communicate with a lottery host to determine if the virtual reward redemption code is a winner.

If the virtual reward redemption code is a winner, the procedure proceeds to 306. If the virtual reward redemption code is not a winner, the procedure ends in 308. A player will be unable to redeem a virtual reward redemption code that is not a winner.

In 306, a prize may be provided to the player on the MMOG server. The prize may be a virtual reward. For example, a virtual reward may be a virtual object used in a video game, such as a MMOG. The virtual reward may also be any effect on an avatar or opportunities available to an avatar in the video game. For example, the attributes or characteristics of the avatar may be modified.

An example virtual object may be currency of the MMOG, such as gold or credits. Experience points and additional experience levels may also be available. Virtual objects such as in-game pets, armor, weapons may also be available.

The virtual reward may be an opportunity to participate in a virtual event. For example, the virtual event may be a quest within the MMOG, an opportunity to participate in a drawing or competition, or admittance to a private area or group within the MMOG.

The virtual reward may be the ability to modify the characteristics of an avatar. For example, an avatar may have be modified to gain special abilities or characteristics.

The prize may be a chance to win an award. The MMOG host may first determine a category of virtual reward to be awarded. The MMOG server may then determine the virtual reward within that category.

Along with the prize, the host may provide a receipt to the player. The receipt may include the player's win information, such as the winning game piece data, the prize won, the date and time of winning, or an advertisement.

FIG. 3a illustrates a second example procedure for conducting a wagering game, according to an example embodiment of the present invention. In 350, a game piece may be provided to a player. The player may purchase the game piece at a convenience store, a lottery ticket kiosk, or other location where lottery tickets are available. For example, a player may purchase a game piece with cash, credit card, debit card, points, or other consideration. Alternatively, a player may receive the game piece for free or on a promotional basis.

The game piece may include a lottery game. For example, the lottery game may be a scratch and win game, a future draw game, or an online lottery game. The game piece may include a game piece data and a game piece identifier

In 352, the player may submit the game piece identifier for redemption to a MMOG terminal. The game piece identifier may be an alpha-numeric sequence.

In 354, the MMOG terminal may submit the game piece identifier to a MMOG host. The MMOG terminal may be a personal computer, a gaming console, a mobile phone, a wireless personal digital assistant (PDA), a video lottery terminal, a slot machine, a video slot machine or any other terminal configured to communicate with a host.

In 356, the MMOG host may determine if the game piece identifier is a winner. The host may include a table of winning game piece identifiers. In this example, the host will look up the game piece identifier in the table to determine if the game piece identifier is a winner. Alternatively, the host may randomly select the winning status of a game piece identifier when it is submitted. The host may first verify the authenticity of the game piece identifier. For example, the game piece identifier may be encoded with a checksum value or other security measure. Alternatively, the MMOG host may communicate with a lottery host to determine if the game piece identifier is a winner.

If the game piece identifier is a winner, the procedure proceeds to step 358. If the game piece identifier is not a winner, the procedure ends in 360. A player will be unable to redeem a game piece identifier that is not a winner.

In 358, a prize may be provided to the player on the MMOG server. The prize may be a virtual reward. For example, a virtual reward may be a virtual object used in a video game, such as a MMOG. The virtual reward may also be any effect on an avatar or opportunities available to an avatar in the video game.

An example virtual object may be currency of the MMOG, such as gold or credits. Experience points and additional experience levels may also be available. Virtual objects such as in-game pets, armor, weapons may also be available.

The virtual reward may be an opportunity to participate in a virtual event. For example, the virtual event may be a quest within the MMOG, an opportunity to participate in a drawing or competition, or admittance to a private area or group within the MMOG.

The virtual reward may be the ability to modify the characteristics of an avatar. For example, an avatar may have special abilities or characteristics.

The prize may be a chance to win an award. If the MMOG host may first determine a category of virtual reward to be awarded. The MMOG server may then determine the virtual reward within that category.

Along with the prize, the host may provide a receipt to the player. The receipt may include the player's win information, such as the winning game piece data, the prize won, the date and time of winning, or an advertisement.

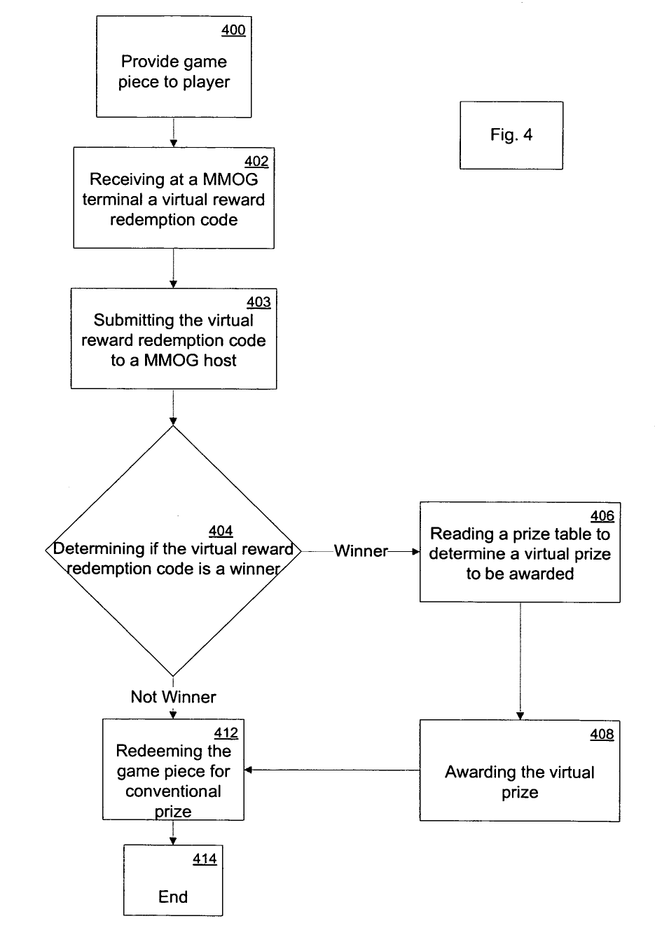

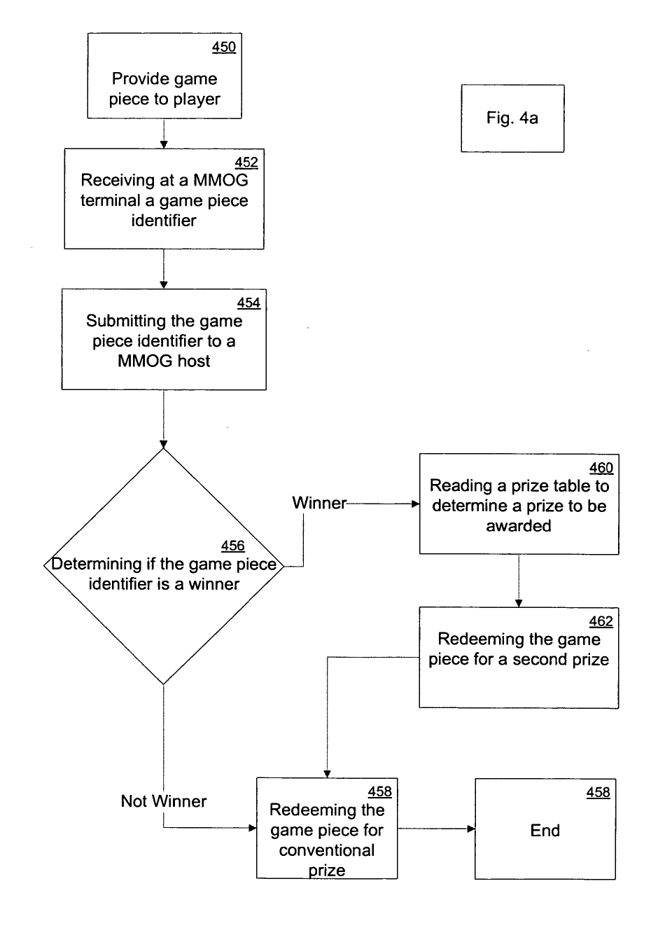

FIG. 4 illustrates a third example procedure for conducting a wagering game, according to an example embodiment of the present invention. In 400, a game piece may be provided to a player. The player may purchase the game piece at a convenience store, a lottery ticket kiosk, or other location where lottery tickets are available. For example, a player may purchase a game piece with cash, credit card, debit card, points, or other consideration. Alternatively, a player may receive the game piece for free or on a promotional basis.

The game piece may include a lottery game. For example, the lottery game may be an instant win game, a future draw game, or an online lottery game. The game piece may include a game piece data. The game piece may also include a virtual reward redemption code.

In 402, the player may submit the virtual reward redemption code for redemption to a MMOG terminal. The virtual reward redemption code may be an alpha-numeric sequence.

In 403, the MMOG terminal may submit the virtual reward redemption code to a MMOG host. The MMOG terminal may be a personal computer, a gaming console, a mobile phone, a wireless personal digital assistant (PDA), a video lottery terminal, a slot machine, a video slot machine or any other terminal configured to communicate with a host.

In 404, the MMOG host may determine if the virtual reward redemption code is a winner. The host may include a table of winning virtual reward redemption codes. In this example, the host will look up the virtual reward redemption code in the table to determine if the virtual reward redemption code is a winner. Alternatively, the host may randomly select the winning status of a virtual reward redemption code as it is received. The host may first verify the authenticity of the virtual reward redemption code. For example, the virtual reward redemption code may be encoded with a checksum value or other security measure. Alternatively, the MMOG host may communicate with a lottery host to determine if the virtual reward redemption code is a winner.

If the virtual reward redemption code is a winner, the procedure proceeds to step 406. If the virtual reward redemption code is not a winner, the procedure proceeds to 412. A player will be unable to redeem a virtual reward redemption code that is not a winner. In 412, a player may redeem the game piece for a conventional prize. For example, conventional prizes may be cash, merchandise, or other benefits for a player. Certain prizes, for example, large cash awards or valuable merchandise, may be diverted and must be redeemed at an authorized lottery game agent. Other prizes may be redeemed at a lottery terminal. The procedure then ends in 414.

In 406, the MMOG host may determine a virtual prize to be awarded by reading a prize table. Alternatively, the MMOG host may inform a lottery host of the virtual reward redemption code submitted by the player. In this example, the lottery host may read a prize table to determine a virtual prize to be awarded.

In 408, a prize may be provided to the player on the MMOG server. The prize may be a virtual reward. For example, a virtual reward may be a virtual object used in a video game, such as a MMOG. The virtual reward may also be any effect on an avatar or opportunities available to an avatar in the video game.

An example virtual object may be currency of the MMOG, such as gold or credits. Experience points and additional experience levels may also be available. Virtual objects such as in-game pets, armor, weapons may also be available.

The virtual reward may be an opportunity to participate in a virtual event. For example, the virtual event may be a quest within the MMOG, an opportunity to participate in a drawing or competition, or admittance to a private area or group within the MMOG.

The virtual reward may be the ability to modify the characteristics of an avatar. For example, an avatar may have special abilities or characteristics.

The prize may be a chance to win an award. If the MMOG host may first determine a category of virtual reward to be awarded. The MMOG server may then determine the virtual reward within that category.

Along with the prize, the host may provide a receipt to the player. The receipt may include the player's win information, such as the winning game piece data, the prize won, the date and time of winning, or an advertisement.

The procedure then proceeds to 412.

FIG. 4a illustrates a fourth example procedure for conducting a wagering game, according to an example embodiment of the present invention. In 450, a game piece may be provided to a player. The player may purchase the game piece at a convenience store, a lottery ticket kiosk, or other location where lottery tickets are available. For example, a player may purchase a game piece with cash, credit card, points, or other consideration. Alternatively, a player may receive the game piece for free.

The game piece may include a lottery game. For example, the lottery game may be an instant win game, a future draw game, or an online lottery game. The game piece may include a game piece data. The game piece may include a game piece data and a game piece identifier.

In 452, the player may submit the game piece identifier for redemption to a MMOG terminal. The game piece identifier may be an alpha-numeric sequence.

In 454, the MMOG terminal may submit the game piece identifier to a MMOG host. The MMOG terminal may be a personal computer, a gaming console, a mobile phone, a wireless personal digital assistant (PDA), a video lottery terminal, a slot machine, a video slot machine or any other terminal configured to communicate with a host.

In 456, the MMOG host may determine if the game piece identifier is a winner. The host may include a table of winning game piece identifiers. In this example, the host will look up the game piece identifier in the table to determine if the game piece identifier is a winner. Alternatively, the host may randomly select the winning status of a game piece identifier as it is submitted. The host may first verify the authenticity of the game piece identifier. For example, the game piece identifier may be encoded with a checksum value or other security measure. Alternatively, the MMOG host may communicate with a lottery host to determine if the game piece identifier is a winner.

If the game piece identifier is a winner, the procedure proceeds to step 460. If the game piece identifier is not a winner, the procedure proceeds to 458. A player will be unable to redeem a game piece identifier that is not a winner. In 458 a player may redeem the game piece for a conventional prize. For example, conventional prizes may be cash, merchandise, or other benefits for a player. Certain prizes may be diverted and must be redeemed at an authorized lottery game agent. Other prizes may be redeemed at a lottery terminal. The procedure then ends in 458.

In 460, the MMOG host may determine a virtual prize to be awarded by reading a prize table. Alternatively, the MMOG host may inform a lottery host of the virtual reward redemption code submitted by the player. In this example, the lottery host may read a prize table to determine a virtual prize to be awarded.

In 462, a prize may be provided to the player on the MMOG server. The prize may be a virtual reward. For example, a virtual reward may be a virtual object used in a video game, such as a MMOG. The virtual reward may also be any effect on an avatar or opportunities available to an avatar in the video game.

An example virtual object may be currency of the MMOG, such as gold or credits. Experience points and additional experience levels may also be available. Virtual objects such as in-game pets, armor, weapons may also be available.

The virtual reward may be an opportunity to participate in a virtual event. For example, the virtual event may be a quest within the MMOG, an opportunity to participate in a drawing or competition, or admittance to a private area or group within the MMOG.

The virtual reward may be the ability to modify the characteristics of an avatar. For example, an avatar may have special abilities or characteristics.

The prize may be a chance to win an award. If the MMOG host may first determine a category of virtual reward to be awarded. The MMOG server may then determine the virtual reward within that category.

Along with the prize, the host may provide a receipt to the player. The receipt may include the player's win information, such as the winning game piece data, the prize won, the date and time of winning, or an advertisement.

The procedure then proceeds to 458.

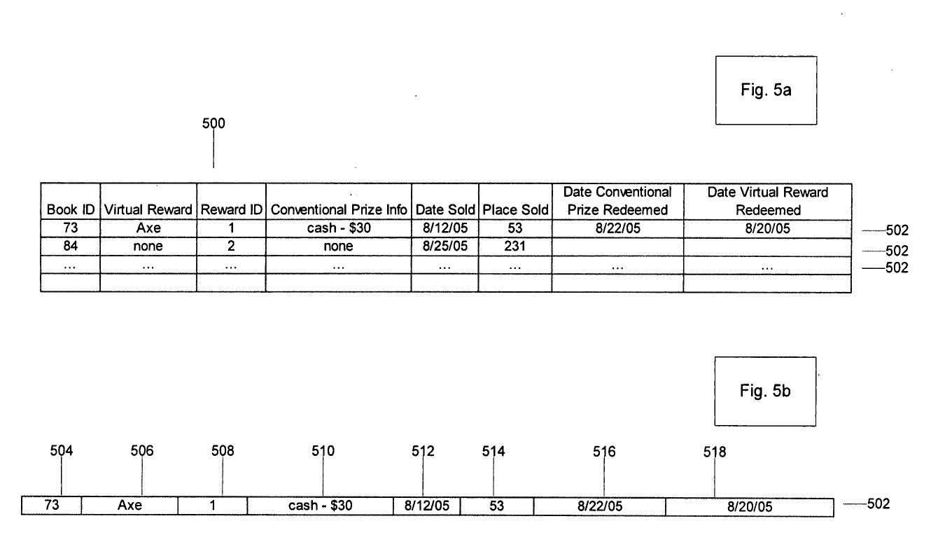

FIG. 5a illustrates an example embodiment of a game ticket information table, according to another example embodiment of the present invention. The game ticket information 202 as depicted in FIG. 2 may be stored as a game ticket information table 500. The game ticket information table 500 may include a plurality of records 502, each record 502 representing one lottery ticket.

It will be appreciated that the game ticket information table 500 may be stored in a variety of ways. For example, it may be stored as a tab delimited or comma delimited flat file, in a relational database or another storage method accessible to a lottery host. The game ticket information table 500 may be used for accounting, auditing, or fraud-detection purposes. For example, the game ticket information table 500 may be checked for abnormally high concentration of prizes being sold from a particular location or to a particular player or set of players.

FIG. 5b illustrates an example embodiment of a game ticket information table entry, according to an example embodiment of the present invention. Each game ticket information table entry may be a record 502. Each record 502 may contain a variety of information, such as a book ID 504. Each book of lottery tickets loaded into a lottery ticket dispenser may contain multiple lottery tickets. The book ID 504 may be an identifier that identifies a book that the lottery ticket was sold from. The identifier may be an alpha-numeric sequence of characters.

The record 502 may also include a virtual reward information 506. The virtual reward information 506 may be a description of the virtual reward associated with the lottery ticket. The virtual reward can be any reward usable on a MMOG, as previously discussed. For example, the virtual reward information 506 may describe a virtual object usable in a MMOG.

The record 502 may also include a reward identifier 508. The reward identifier 508 may be an identifier to identify what virtual reward is associated with the lottery ticket. The reward identifier may be an alpha-numeric sequence of characters.

The record 502 may also include information on the conventional prize awarded 510. Conventional prize information 510 may be a short description or identifier of the conventional prize associated with the lottery ticket. Alternatively, the conventional prize information 510 may be an identifier identifying the conventional associated with the lottery ticket. The identifier may be an alpha-numeric sequence of characters.

The record 502 may also include date the lottery ticket was sold 512. For example, the date the lottery ticket was sold may be when the player received his ticket, when the player's payment was received, or when the ticket was delivered to the seller of the ticket. For example, the seller of the ticket may be a convenience store or an automated kiosk.

The record 502 may also include the location the lottery ticket was sold from 514. The location 514 may be an identifier or a text description. The location 514 may also include a description of the terminal that sold the lottery ticket. For example, a lottery ticket may be sold from a automated kiosk or from an authorized lottery ticket agent. For example, an authorized lottery ticket agent may be a clerk at a convenience store check out counter.

The record 502 may also include the date the conventional prize was redeemed 516. This field may be updated when the ticket is redeemed for the conventional prize.

The record 502 may also include the date the virtual reward was redeemed 518. This field may be updated when the ticket is redeemed for the virtual prize.

FIG. 6 illustrates an example procedure for communication between a lottery host and a MMOG host, according to another example embodiment of the present invention. In 600, a MMOG host may receive a virtual prize redemption code. Alternatively, 600 and the remainder of this procedure may be carried out for a game piece identifier as well. For example, the MMOG host may receive the virtual prize redemption code from a MMOG terminal. A player may log into his MMOG account through the MMOG terminal and submit his virtual prize redemption code.

In 602, the MMOG host may verify the virtual prize redemption code. For example, the virtual prize redemption code may have been encoded with a checksum. For example, the MMOG host may include a list of virtual prize redemption codes or a special format for virtual prize redemption codes or a checksum algorithm that are valid.

In 604, the MMOG host the MMOG host may transmit the virtual prize redemption code to a lottery host. The lottery host may be configured to transmit and receive information needed to run a lottery game. The transmission may occur over a network, the Internet, or a dedicated communication link. The transmission may be encrypted or otherwise secured.

In 606, the lottery host may receive the virtual prize redemption code. If the transmission was encrypted, the lottery host may decrypt it.

In 608, the lottery host may search a prize table for the prize associated with the received virtual prize redemption code. The prize table may be as depicted in FIG. 5 as the game ticket information 202. If the virtual prize redemption code is not found in the prize table, an error may be signaled.

In 610, the lottery host may update the prize table. For example, the lottery host may first read the associated virtual prize information into memory. The lottery host may then update the record to include the date the virtual reward was redeemed and other information. The record may be marked as redeemed.

In 612, the lottery host may send the associated virtual prize information to the MMOG host. The transmission may occur over a network, the Internet, or a dedicated communication link. The transmission may be encrypted or otherwise secured.

In 614, the MMOG host may receive the virtual prize information. The MMOG host may verify the transmission is authentic through an encryption or electronic signature scheme.

In 616, the MMOG host may award the virtual prize to the player. The virtual prize may be an object or action beneficial to a player's avatar. The MMOG host may update a player's MMOG account or the player's avatar in the MMOG.

The procedure ends in 618.

FIG. 7 illustrates an example embodiment of the present invention. MMOG host 700 may be a conventional server configured to provide an MMOG environment in the form of a virtual casino. The MMOG host 700 may be configured to run a host software to provide the MMOG environment.

The MMOG host 700 may be connected to a casino host 704. The host software of the MMOG host 700 may be configured to interface with the casino host 704. The casino host 704 provides a virtual casino environment to the MMOG host, where players may interact with the virtual casino environment through their avatars. The virtual casino may provide a variety of games of chances and wagering games, including conventional games. For example, the virtual casino can provide games of blackjack, craps, or other casino games. Other games such as lottery games and keno may also be offered.

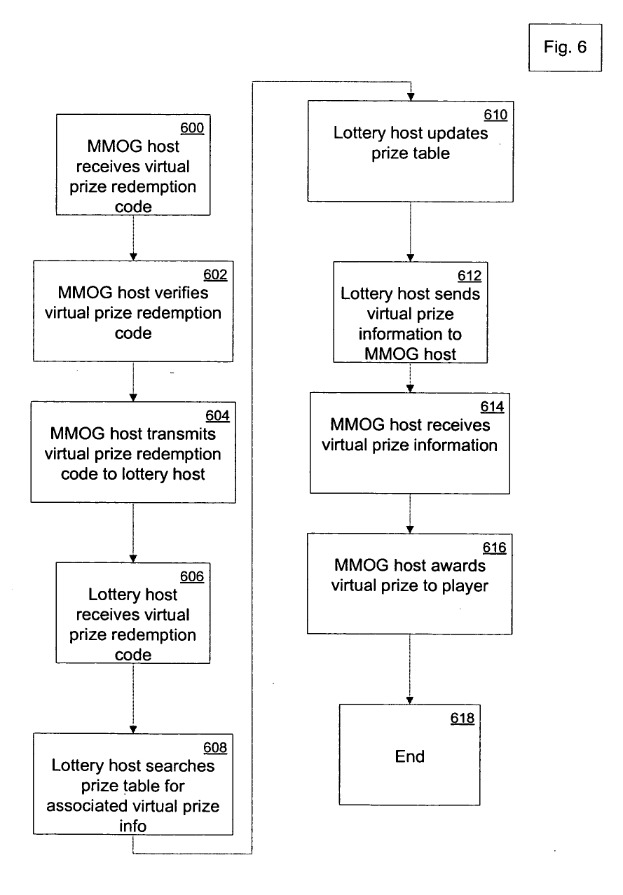

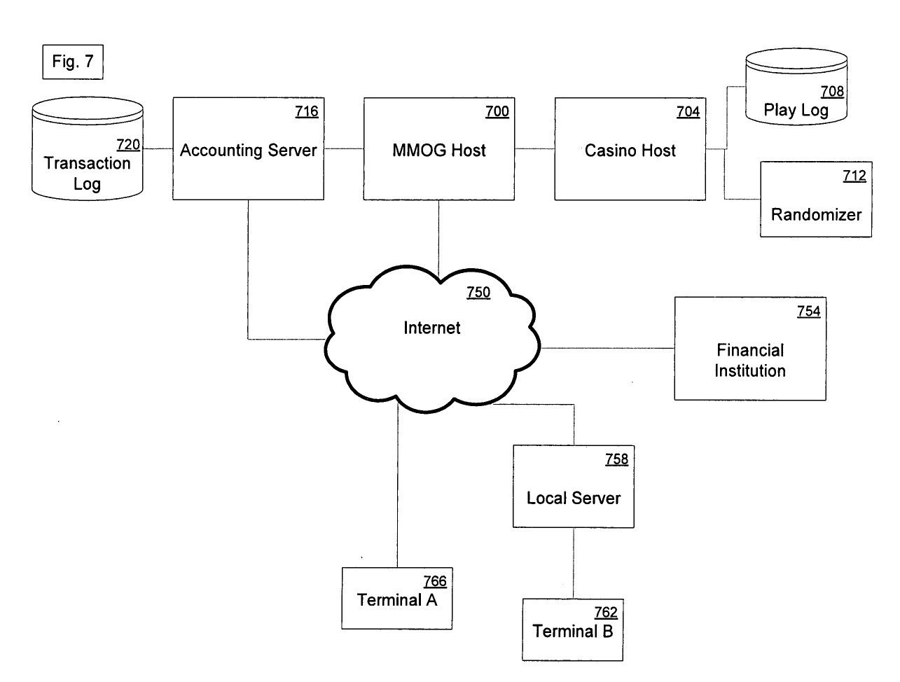

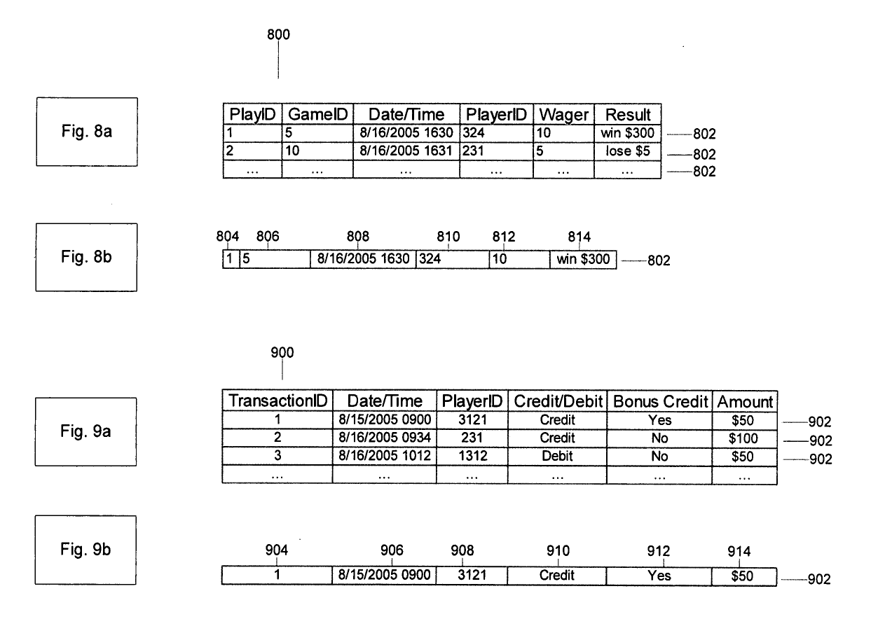

The casino host 704 may be connected to a play log 708 and a randomizer 712. The play log 708 may record and store information regarding individual rounds within each game by each player. For example, each hand of blackjack, each bet in craps or each entry in a lottery game may be a record. An example embodiment of the play log 708 is depicted in FIG. 8a.

The randomizer 712 may provide random numbers or pseudo-random numbers to the casino host 704 in determining outcomes of its casino games and generating game results. The randomizer 712 may accept parameters from the casino host 704 specifying the type of random number to be generated. For example, the output from the randomizer 712 may need to guarantee a certain number of wins in a given number of games.

The MMOG host 700 may also be connected to an accounting server 716. The accounting server 716 may be configured to keep track and update accounts of players. A player's account may be changed through his wins and losses in the virtual casino environment. The player's account may also be changed through withdrawals and deposits. Deposits may be of real currency or bonus currency. Bonus currency may be, for example, a matching bonus given to the player upon initial deposit. Bonus currency may also be currency won as a virtual reward.

The accounting server 716 may also be connected to the transaction log 720. The transaction log 720 may include information on transactions over the accounting server. An example embodiment of the transaction log 720 is depicted in FIG. 8b. The transaction log 720 may be stored in a relational database, a flat file, or other storage method.

The accounting server 716 and the MMOG host 700 may be connected to the Internet 750 and be configured to communicate over the Internet. The communications may be encrypted or otherwise protected by security measures such as checksums or virtual signatures.

The accounting server 716 may communicate with a financial institution 754 over the Internet 750. The financial institution 754 may be, for example, a bank or an online payment service. Example online payment services include PayPal and FirePay, available at www.paypal.com and www.firepay.com. A player may deposit or withdraw currency into this MMOG account through his account at the financial institution 754. For example, if the financial institution 754 is a bank, the player may be able to directly transfer money from his account to the accounting server 716 and vice versa.

The MMOG host 700 may communicate to a terminal A 766. The terminal A 766 may be used by a player to log into the MMOG host 700 and control his avatar in the virtual casino environment. The terminal A 766 may be a personal computer, a wireless device or a specialized gaming device.

The MMOG host 700 may also communicate with a local server 758. The local server 758 may be used as an intermediary between the MMOG host 700 and a terminal B 762. The terminal B 762 may be used by a player to log into the MMOG host 700 and control his avatar in the virtual casino environment. The terminal B 762 may be a personal computer, a wireless device or a specialized gaming device.

FIG. 8a illustrates an example embodiment of a play log table, according to an example embodiment of the present invention. The play log table 800 may include a plurality records 802. Each record 802 may represent one wager in the virtual casino. For example, one hand of blackjack, one pull on a slot machine, or one ticket in keno may all be one wager.

It will be appreciated that the play log table 800 may be stored in a variety of ways. For example, it may be stored as a tab delimited or comma delimited flat file, in a relational database or another storage method accessible to a lottery host. The play log table 800 may be used for accounting, auditing, game protection or fraud-detection purposes. For example, the virtual casino may need to ensure that a certain amount of currency is paid out in winnings. Alternatively, the play log table 800 may be used to check for abnormally high incidence or concentration of winnings to particular players or in particular games.

FIG. 8b illustrates an example embodiment of a play log table entry, according to an example embodiment of the present invention. Each play log table entry may be a record 802. Each record 802 may contain a variety of information, such as an identifier of a play PlayID 804. The PlayID 804 may be a unique identifier associated with a wager made in the virtual casino. The PlayID 804 may be an alpha-numeric sequence of characters or other method of distinctly identifying the record 802.

The record 802 may also include a GameID 806 of a game played. The GameID 806 may be an identifier associated with the game played. There may be a plurality of games available in the virtual casino, and each game may be associated with a unique identifier. For example, each game may be a different type of game as well as a different rule variant. For example, game types may include blackjack, craps, roulette, keno, lottery, horse racing, or sports betting. For example, blackjack may have different rule variants such as how may decks of cards are used and rules on game play, such as when a player may double down on a wager or split pairs of cards. The GameID 806 may be an alpha-numeric sequence of characters or other method of distinctly identifying the game played by the player.

The record 802 may include a Date/Time of the play. The Date/Time 808 may be the date and time the wager was made. Alternatively, the Date/Time 808 may be the date and time the wager result was decided, and winnings are paid to or losses collected from the player.

The record 802 may include a PlayerID 810 of the player who made the play. Each player in the virtual casino may have a player account on the virtual casino server. The player account may be associated with a PlayerID 810 identifier. The PlayerID 810 may be an alpha-numeric sequence of characters or other method of distinctly identifying players in the virtual casino.

The record 802 may include a Wager 812 made on the play. The wager 812 may be the amount of currency the player bet on the play.

The record 802 may include a Result 814 of the play. The result 814 may describe whether the wager was won or lost, and how the amount of winnings or losses.

FIG. 9a illustrates an example embodiment of a transaction log table, according to an example embodiment of the present invention. The transaction log table 900 may include a plurality of records 902. Each record 902 may represent one transaction to a player's account in the virtual casino. For example, a player may deposit currency into the virtual casino for a credit to his account. Alternatively, a player may withdraw currency from the virtual casino for a debit to his account.

It will be appreciated that the transaction log table 900 may be stored in a variety of ways. For example, it may be stored as a tab delimited or comma delimited flat file, in a relational database or another storage method accessible to a lottery host. The transaction log table 900 may be used for accounting, auditing, game protection or fraud-detection purposes. For example, the virtual casino may need to track a player's deposits and withdrawals to comply with law enforcement requirements. Alternatively, the transaction log table 900 may be used to check for abnormal or suspicious patterns of deposits or withdrawals.

FIG. 9b illustrates an example embodiment of a transaction log table entry, according to an example embodiment of the present invention. Each transaction log table entry may be a record 902. Each record 902 may contain a variety of information, such as a TransactionID 904 of the transaction. The TransactionID 904 may be a unique identifier associated with a transaction in the virtual casino. The TransactionID 904 may be an alpha-numeric sequence of characters or other method of distinctly identifying the record 902.

The record 902 may also include a Date/Time 906 of the transaction. The Date/Time 906 may be the date and time the transaction was made. Alternatively, the Date/Time 906 may be the date and time the transaction cleared or was settled.

The record 902 may also include a PlayerID 908 of the player conducting the transaction. Each player in the virtual casino may have a player account on the virtual casino server. The player account may be associated with a PlayerID 908 identifier. The PlayerID 908 may be an alpha-numeric sequence of characters or other method of distinctly identifying players in the virtual casino.

The record 902 may also include a Credit/Debit indicator 910 to indicate whether the transaction was a credit or a debit to the player's account. The credit/debit indicator 910 may be stored as a binary value, with true being equal to a credit transaction and a false being equal to a debit transaction. Alternatively, the credit/debit indicator 910 may be a text field with possible values of “credit” or “debit.”

The record 902 may also include a Bonus Credit indicator 912 to indicate whether a credit transaction was a bonus transaction. For example, a bonus transaction may be an initial deposit bonus, where a bonus is provided with a player's initial deposit. Alternatively, the bonus transaction may be a virtual reward from a lottery game.

The record 902 may also include an Amount 914 of the transaction. The amount 914 may describe the amount of currency credited to or debited from the player's account.

### MODIFICATIONS

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method of conducting a wagering game, comprising:
providing a game piece to a player, the game piece including game play data and a virtual reward redemption code;
redeeming the game piece for a monetary prize, the value of the monetary prize depending on the game play data;
submitting the virtual reward redemption code to a host;
using the virtual reward redemption code to determine if the player is a winner of a virtual reward; and
if the player is a winner of the virtual reward, providing the virtual reward as a prize to the player.

2. A method of claim 1, wherein the virtual reward is a virtual object used in a video game.

3. A method of claim 1, wherein the virtual reward is an opportunity to participate in a virtual event.

4. A method of claim 1, wherein the virtual reward is an opportunity to modify an avatar.

5. A method of claim 1, wherein the virtual reward is a chance to win a reward.

6. A method of claim 1, wherein the virtual reward depends on the game play data.

7. A method of claim 1, further comprising:
reading a prize table to determine the virtual prize to be awarded.

8. A method of claim 1, further comprising:
redeeming the game piece for a second prize depending on a game play data included on the game piece, the second prize being a monetary award.

9. A method of claim 1, wherein the virtual reward code is submitted to the host over the Internet.

10. A method of claim 2, wherein the video game is a MMOG.

11. A method of claim 1, wherein the game piece is a scratch off lottery ticket.

12. A method of claim 1, wherein the game piece is a future draw game piece.

13. A method of claim 1, wherein the game piece is an online lottery ticket.

14. A method of conducting a wagering game, comprising:
providing a game piece to a player, the game piece including a game piece identifier and game play data for the wagering game;
redeeming the game piece for a monetary prize in the wagering game, the prize depending on the game play data;
receiving a request to redeem the game piece for a virtual prize, the request including the game piece identifier;
determining if the game piece identifier is associated with a virtual reward winning game piece; and
if the game piece is a virtual reward winning game piece, providing the virtual reward as a prize to the player.

15. A method of claim 14, wherein the virtual reward is a virtual object used in a video game.

16. A method of claim 14, wherein the virtual reward is an opportunity to participate in a virtual event.

17. A method of claim 14, wherein the virtual reward is an opportunity to modify an avatar.

18. A method of claim 14, wherein the virtual reward is a chance to win a reward.

19. A method of claim 14, wherein the virtual reward is a category of prize to be awarded.

20. A method of claim 14, further comprising:
reading a prize table to determine the virtual prize to be awarded.

21. A method of claim 15, wherein the video game is a MMOG.

22. A method of claim 14, wherein the game piece is a scratch off lottery ticket.

23. A method of claim 14, wherein the game piece is a future draw game piece.

24. A method of claim 14, wherein the game piece is an online lottery game piece.

25. A method of conducting a wagering game on a gaming device, comprising:
providing a chance in the wagering game to a player;
determining if the chance is a winning chance in the wagering game;
providing a monetary prize to the player if the chance is a winning chance in the wagering game; and
providing a virtual reward as a prize to the player.

26. A method of claim 25, wherein the gaming device is a video lottery terminal.

27. A method of claim 25, wherein the gaming device is a slot machine.

28. A method of claim 25, wherein the virtual reward is a virtual object used in a video game.

29. A method of claim 25, further comprising:
providing a receipt to a player, the receipt including a win information.

30. A method of claim 29, wherein the prize is provided by a terminal after the player enters the win information into the terminal.

31. A system for conducting a wagering game in accordance to a set of pre-determined game rules, comprising:
a host;
a gaming terminal, the gaming terminal in communication with the host;
a game piece provided to a player, the game piece including game play data;
a virtual reward redemption code, the virtual reward redemption code included on the game piece; and
a virtual reward, the virtual reward awarded to a player after submission of the virtual reward redemption code if game play data indicates the game piece is a winner in accordance to the set of predetermined game rules.

32. A system for conducting a wagering game, comprising:
a host;
a gaming terminal, the gaming terminal in communication with the host;
a game piece provided to a player;
a game piece identifier, the game piece identifier included on the game piece; and
a virtual reward, the virtual reward awarded to a player after submission of the game piece identifier if the game piece identifier is associated with a winning game piece.

33. A lottery ticket, comprising:
a game data to indicate the outcome of a lottery game;
a ticket identifier; and
a virtual reward redemption code, the virtual reward redemption code configured to be submitted by a holder of the lottery ticket to receive a virtual reward in an MMOG.

34. The lottery ticket of claim 33, wherein the virtual reward redemption code is included in the ticket identifier.

35. A computer-readable medium storing instructions adapted to be executed by a processor, the instructions, when executed, defining a method for conducting a wagering game, the method comprising:
providing a game piece to a player, the game piece including game play data and a virtual reward redemption code;
redeeming the game piece for a monetary prize, the value of the monetary prize depending on the game play data;
submitting the virtual reward redemption code to a host;
using the virtual reward redemption code to determine if the player is a winner of a virtual reward; and
if the player is a winner of the virtual reward, providing the virtual reward as a prize to the player.

36. A computer-readable medium storing instructions adapted to be executed by a processor, the instructions, when executed, defining a method for conducting a wagering game, the method comprising:
providing a game piece to a player, the game piece including a game piece identifier and game play data for the wagering game;
redeeming the game piece for a monetary prize in the wagering game, the prize depending on the game play data;
receiving a request to redeem the game piece for a virtual prize, the request including the game piece identifier;
determining if the game piece identifier is associated with a virtual reward winning game piece; and
if the game piece is a virtual reward winning game piece, providing the virtual reward as a prize to the player.

37. A method of claim 1, wherein the virtual reward is currency usable in a virtual casino.

38. A method of claim 14, wherein the virtual reward is currency usable in a virtual casino.
